(19) United States
(12) Patent Application Publication
(10) Pub. No.: US 2026/0289323 A1
(43) Pub. Date: Sep. 24, 2026

(54) MODEL UPDATING

(71) Applicant: Nokia Solutions and Networks Oy, Espoo (FI)

(72) Inventors: Jian SONG, Palaiseau (FR); István Zsolt KOVÁCS, Aalborg (DK); Sakira HASSAN, Espoo (FI); Afef FEKI, Sceaux (FR); Ahmad MASRI, Tampere (FI); Amaanat ALI, Espoo (FI); Dick CARRILLO MELGAREJO, Lappeenranta (FI)

(73) Assignee: Nokia Solutions and Networks Oy, Espoo (FI)

(21) Appl. No.: 19/474,508

(22) PCT Filed: Apr. 12, 2023
(86) PCT No.: PCT/EP2023/059497

§ 371 Date: Oct. 10, 2025

(51) Int. Cl. G06N 3/096

(52) U.S. Cl. CPC G06N 3/096

(57) ABSTRACT

An apparatus, method and computer program is described comprising: exchanging configuration information with a user device of a mobile communication system; selecting a student model from a set of student model architectures transferring the selected student model, or an identifier of the selected student model, to the user device for training; calculating a reward value based, at least in part, on one or more performance metrics for the selected student algorithm for a given use case; and updating the student model based on the calculated reward value and/or a reinforcement learning policy for the given use case.

### FIELD

The present specification relates to updating a model for use in a user device, such as a user device of a mobile communication system.

### BACKGROUND

Knowledge distillation is a process that can be used to transfer knowledge from a large model, such as a deep neural network, to a smaller model. The larger model may be referred to as a teacher model and the smaller model may be referred to as a student model. By way of example, a student model may be used within a user device of a mobile communication system.

### SUMMARY

In a first aspect, this specification describes apparatus comprising means for performing: exchanging configuration information with a user device of a mobile communication system; selecting a student model from a set of student model architectures, wherein each student model architecture in the set is derived from a teacher model for implementing a function at said user device (and may be simpler than the teacher model in some way, e.g. in terms of network layout, number of hidden layers, hyper-parameters, etc.); transferring the selected student model, or an identifier of the selected student model, to the user device for training and inference; calculating a reward value based, at least in part, on one or more performance metrics (e.g. based a weighted sum of performance metrics) for the selected student algorithm for a given use case; and updating the student model based on the calculated reward value and/or a reinforcement learning policy for the given use case. The apparatus may be an agent or similar module on the network side (e.g. at a gNB) that controls adaptation and/or optimization of a student model for deployment, for example, at a particular user device. The apparatus may be a network node of the mobile communication system.

The apparatus may further comprise means for performing: repeating the selecting, transferring, calculating and updating steps above (for example, based on reinforcement learning principles).

The apparatus may further comprising means for performing: receiving at least some of said performance metrics from said user device. At least some of said performance metrics may be generated at the user device (e.g. with or without the assistance of a network node).

The performance metrics may include an evaluation score associated with a performance of the respective student network. Alternatively, or in addition, the performance metrics may include radio performance key performance indicators for a given use case.

The configuration information may include a state space configuration. The state space may comprise a plurality of bits (e.g. 2-bits) for use in quantifying said performance metrics, wherein said state space configuration defines the number and nature of said bits. One or more bits (e.g. a first bit) of said state space may indicate whether or not a model quality assessment for a student model is above a threshold score. Alternatively, or in addition, one or more bits (e.g. a second bit) of said state space indicates whether radio key performance indicators are above a threshold satisfaction level.

The said configuration information may include an action space configuration. The action space may comprise all model architectures that can be derived from the teacher model.

The apparatus may further comprise a policy in the form of a look-up table that collates at least some of said performance metrics and rewards.

In a second aspect, this specification describes an apparatus (such as a user device of a mobile communication system), the apparatus comprising means for performing: exchanging configuration information with a network node of a mobile communication system; receiving a student model, or an identifier of the student model, from the network node, for training and inference, wherein said student model is selected from a set of student model architectures, wherein each student model architecture in the set is derived from a teacher model for implementing a function at said user device (and may be simpler than the teacher model in some way, e.g. in terms of network layout, number of hidden layers, hyper-parameters, etc.); and providing at least some information to the network node, for use in updating the student model based, at least in part, on a said information. The said information may include performance metrics for the student model for a given use case. The performance metrics may include an evaluation score associated with a performance of the respective student network. Alternatively, or in addition, the performance metrics may include radio performance key performance indicators for a given use case.

The configuration information may include a state space configuration. The state space may comprise a plurality of bits (e.g. 2-bits) for use in quantifying said performance metrics, wherein said state space configuration defines the number and nature of said bits. One or more bits (e.g. a first bit) of said state space may indicate whether or not a model quality assessment for a student model is above a threshold score. Alternatively, or in addition, one or more bits (e.g. a second bit) of said state space indicates whether radio key performance indicators are above a threshold satisfaction level.

The said configuration information may include an action space configuration. The action space may comprise all model architectures that can be derived from the teacher model.

The apparatus may further comprise a policy in the form of a look-up table that collates at least some of said performance metrics and rewards.

In a third aspect, this specification describes a method comprising: exchanging configuration information with a user device of a mobile communication system; selecting a student model from a set of student model architectures, wherein each student model architecture in the set is derived from a teacher model for implementing a function at said user device; transferring the selected student model, or an identifier of the selected student model, to the user device for training and inference; calculating a reward value based, at least in part, on one or more performance metrics (e.g. based a weighted sum of performance metrics) for the selected student algorithm for a given use case; updating the student model based on the calculated reward value and/or a reinforcement learning policy for the given use case; and repeating the selecting, transferring, calculating and updating steps above.

The method may further comprise: repeating the selecting, transferring, calculating and updating steps above (for example, based on reinforcement learning principles).

The method may further comprise receiving at least some of said performance metrics from said user device. At least some of said performance metrics may be generated at the user device (e.g. with or without the assistance of a network node).

The performance metrics may include an evaluation score associated with a performance of the respective student network. Alternatively, or in addition, the performance metrics may include radio performance key performance indicators for a given use case.

The configuration information may include a state space configuration. The state space may comprise a plurality of bits (e.g. 2-bits) for use in quantifying said performance metrics, wherein said state space configuration defines the number and nature of said bits. One or more bits (e.g. a first bit) of said state space may indicate whether or not a model quality assessment for a student model is above a threshold score. Alternatively, or in addition, one or more bits (e.g. a second bit) of said state space indicates whether radio key performance indicators are above a threshold satisfaction level.

The said configuration information may include an action space configuration.

In a fourth aspect, this specification describes a method comprising: exchanging configuration information with a network node of a mobile communication system;

receiving a student model, or an identifier of the student model, from the network node, for training and inference, wherein said student model is selected from a set of student model architectures, wherein each student model architecture in the set is derived from a teacher model for implementing a function at said user device; and providing at least some information to the network node, for use in updating the student model based, at least in part, on a said information. The said information may include performance metrics for the student model for a given use case. The performance metrics may include an evaluation score associated with a performance of the respective student network. Alternatively, or in addition, the performance metrics may include radio performance key performance indicators for a given use case.

The configuration information may include a state space configuration. The state space may comprise a plurality of bits (e.g. 2-bits) for use in quantifying said performance metrics, wherein said state space configuration defines the number and nature of said bits. One or more bits (e.g. a first bit) of said state space may indicate whether or not a model quality assessment for a student model is above a threshold score. Alternatively, or in addition, one or more bits (e.g. a second bit) of said state space indicates whether radio key performance indicators are above a threshold satisfaction level.

The said configuration information may include an action space configuration.

In a fifth aspect, this specification describes computer-readable instructions which, when executed by a computing apparatus, cause the computing apparatus to perform (at least) any method as described herein (including the methods of the third and fourth aspects described above).

In a sixth aspect, this specification describes a computer-readable medium (such as a non-transitory computer-readable medium) comprising program instructions stored thereon for performing (at least) any method as described herein (including the methods of the third and fourth aspects described above).

In a seventh aspect, this specification describes an apparatus comprising: at least one processor; and at least one memory including computer program code which, when executed by the at least one processor, causes the apparatus to perform (at least) any method as described herein (including the methods of the third and fourth aspects described above).

In an eighth aspect, this specification describes a computer program comprising instructions which, when executed by an apparatus, cause the apparatus to: exchange configuration information with a user device of a mobile communication system; select a student model from a set of student model architectures, wherein each student model architecture in the set is derived from a teacher model for implementing a function at said user device; transfer the selected student model, or an identifier of the selected student model, to the user device for training and inference; calculate a reward value based, at least in part, on one or more performance metrics (e.g. based a weighted sum of performance metrics) for the selected student algorithm for a given use case; update the student model based on the calculated reward value and/or a reinforcement learning policy for the given use case; and repeat the selecting, transferring, calculating and updating steps above.

In a ninth aspect, this specification describes a computer program comprising instructions which, when executed by an apparatus, cause the apparatus to: exchange configuration information with a network node of a mobile communication system; receive a student model, or an identifier of the student model, from the network node, for training and inference, wherein said student model is selected from a set of student model architectures, wherein each student model architecture in the set is derived from a teacher model for implementing a function at said user device; and provide at least some information to the network node, for use in updating the student model based, at least in part, on a said information. The said information may include performance metrics for the student model for a given use case.

In a tenth aspect, this specification describes: a control module (or some other means) for exchanging configuration information with a user device of a mobile communication system; a model selection module (or some other means) for selecting a student model from a set of student model architectures, wherein each student model architecture in the set is derived from a teacher model for implementing a function at said user device; a knowledge transfer module (or some other means) for transferring the selected student model, or an identifier of the selected student model, to the user device for training and inference; an evaluation module (or some other means) for calculating a reward value based, at least in part, on one or more performance metrics for the selected student algorithm for a given use case; a training module (or some other means) for updating the student model based on the calculated reward value and/or a reinforcement learning policy for the given use case; and a model updating module for repeating the selecting, transferring, calculating and updating steps above.

In an eleventh aspect, this specification describes: a control module (or some other means) for exchanging configuration information with a network node of a mobile communication system; a model receiving module (or some other means) for receiving a student model, or an identifier of the student model, from the network node, for training and inference, wherein said student model is selected from a set of student model architectures, wherein each student model architecture in the set is derived from a teacher model for implementing a function at said user device; and a data output module (or some other means) for providing at least some information to the network node, for use in updating the student model based, at least in part, on a said information.

### BRIEF DESCRIPTION OF THE DRAWINGS

Example embodiments will now be described, by way of example only, with reference to the following schematic drawings, in which:

FIG. 1 is a block diagram of an example system;

FIG. 2 is a flow chart showing an algorithm that may be implemented using the system of FIG. 1;

FIG. 3 is a block diagram of a system showing an example teacher-student model architecture;

FIG. 4 is a message flow sequence showing an example implementation of an algorithm in accordance with an example embodiment;

FIG. 5 is a flow chart showing an algorithm in accordance with an example embodiment;

FIG. 6 is a block diagram of models in accordance with an example embodiment;

FIG. 7 is a flow chart showing an algorithm in accordance with an example embodiment;

FIG. 8 is a message flow sequence showing an example implementation of an algorithm in accordance with an example embodiment;

FIG. 9 shows an example state space model, in accordance with an example embodiment;

FIG. 10 is a block diagram of a system in accordance with an example embodiment;

FIG. 11 is a schematic diagram of components of one or more of the example embodiments described previously; and

FIG. 12 shows tangible media for storing computer-readable code which when run by a computer may perform methods according to example embodiments described herein.

### DETAILED DESCRIPTION

The scope of protection sought for various embodiments of the disclosure is set out by the independent claims. The embodiments and features, if any, described in the specification that do not fall under the scope of the independent claims are to be interpreted as examples useful for understanding various embodiments of the disclosure.

In the description and drawings, like reference numerals refer to like elements throughout.

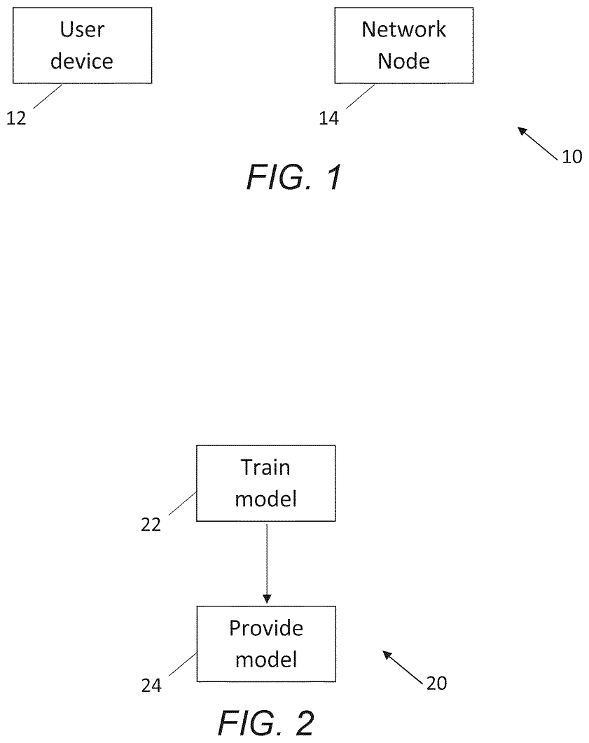

FIG. 1 is a block diagram of an example system, indicated generally by the reference numeral 10. The system 10 comprises a user device 12 and a network node 14. The user device 12 may be a user equipment (UE) of a mobile communication network. The network node 14 may be a gNB or similar node of a mobile communication network.

FIG. 2 is a flow chart showing an algorithm, indicated generally by the reference numeral 20, that may be implemented using the system 10 of FIG. 1.

The algorithm 20 starts at operation 22, where a machine learning (ML) model is trained, for example at the network node 14 of the system 10. At operation 24, the trained model is provided to a user device (such as the user device 12), where it can be deployed. As discussed in detail below, a model trained (or otherwise generated or obtained) on the network side can be transferred to a user device for local training and inference.

The ML model deployed at a UE (such as the user device 12) may be initially trained offline as part of UE production and potentially updated along with the regular firmware updates (e.g. using UE vendor specific cloud solutions). Both procedures are transparent to the 3GPP NG-RAN and related specifications. However, for 3GPP ML-enabled solutions, the underlying ML models may be adjusted or tuned from time-to-time to achieve optimal performance, based on radio information available only during operation in the NG-RAN (IDLE/INACTIVE or CONNECTED mode). Depending on the use case, this ML model update might not be the best to perform independently of the NG-RAN operations, i.e., without any coordination in between the UEs and the network (NW). For example, when the UE ML (re) training requires a new configuration of the reference signals, network assistance for data collection (e.g. labelling) or additional radio resources, the NG-RAN should be made aware of the UE requirements. This collaboration between NG-RAN and UE can also help to improve the quality of the input data/signals needed by the UE for ML (re) training. This is applicable to 3GPP ML-enabled functions with either single- or dual-sided ML models.

Nevertheless, there are computational power restrictions in the UE hardware and software platform (CPU/GPU cores, L1/L2 memory, MAC/cycle, etc.), which are unlikely to be exposed explicitly to the 3GPP network. Such restrictions may impose limits to the amount, frequency and the extent to which the deployed ML model(s) can be (re-) trained on-device, after their deployment, and during normal operation of the UE in the NG-RAN. This can be a relevant problem for supervised learning-based ML solutions in the UE.

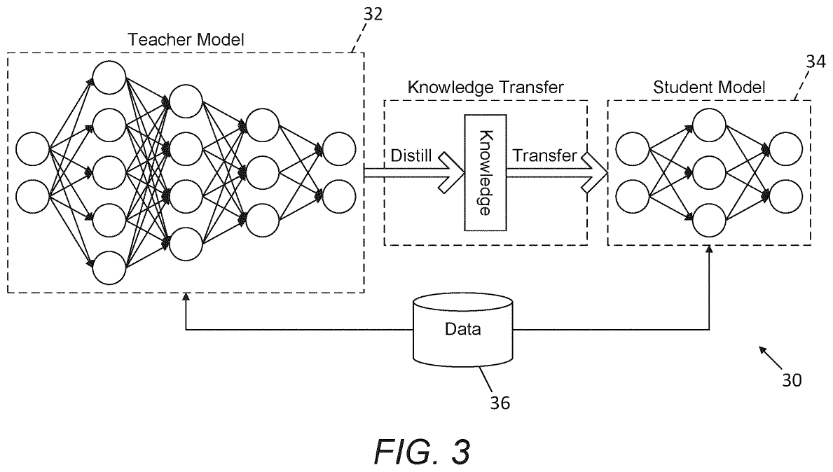

FIG. 3 is a block diagram of a system, indicated generally by the reference numeral 30, showing an example teacher-student model architecture.

The system 30 comprises a teacher model 32 and a student model 34. Knowledge can be transferred from the teacher model 32 to the (simpler) student model 34. Note that during training, both models use the same data 36.

Knowledge distillation is a process that can be used to transfer knowledge from a large model, typically a deep neural network, to a smaller one without the loss of model validation. A benefit of knowledge distillation is that a smaller model will require less computational power for (re) training and inference, as well as requiring less storage. The larger model may be referred to as a teacher model (such as the teacher model 32) and the smaller model may be referred to as a student model (such as the student model 34).

The architecture of teacher-student models may vary depending, for example, on the form of knowledge types (e.g. feature based or response based), the type of learning process (e.g. offline, online, or self-supervised), and the type of algorithms (e.g. adversarial, cross-modal, graph-based, attention-based, etc.).

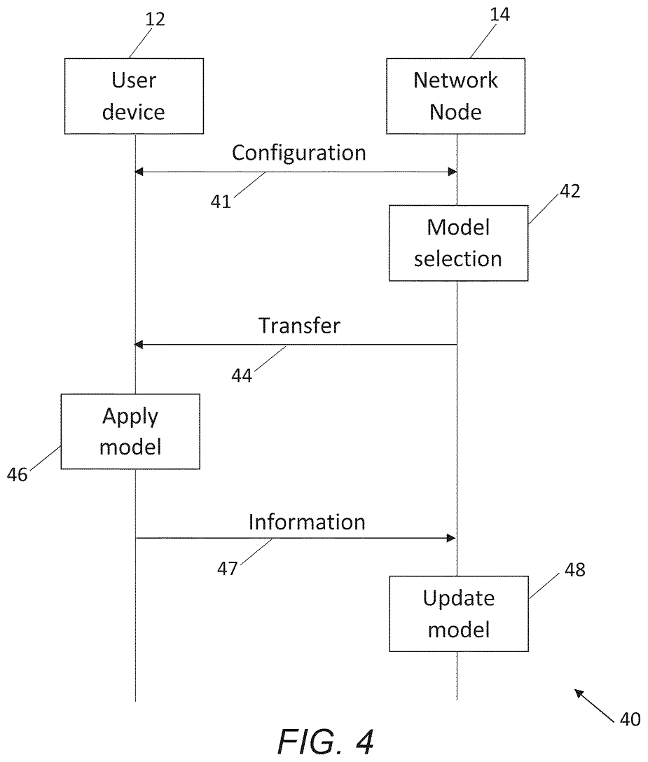

FIG. 4 is a message flow sequence, indicated generally by the reference numeral 40, showing an example implementation of an algorithm in accordance with an example embodiment. The message flow sequence 40 shows a signalling flow between the user device 12 and the network node 14 described above.

As discussed in detail below, the message flow sequence 40 enables the network node 14 to perform efficient online adaptation of a model in the user device 12 by using a teacher-student setup with knowledge distillation. In this way, a good performance with a verified UE student model quality can be achieved under varying conditions (e.g. varying mobility patterns, varying radio conditions, varying traffic conditions, etc).

The sequence 40 starts with configuration information being exchanged between the network node 14 and the user device 12 in message exchange 41. The configuration information may be selected at and determined at the network node. Some or all of said information may be provided to the user device 12, for example on request by the user device. Knowledge of at least some of the configuration information may be useful to the user device when implementing or training the relevant model (for example, in some example embodiments timing constraints and/or learning periodicity should be known by the user device).

At operation 42, a student model is selected from a set of student model architectures at the network node 14. Each of the available student model architectures in the set is derived from a teacher model for implementing a function at the user device 12. The teacher model is typically more complicated in some way that the student models (e.g. in terms of network layout, number of hidden nodes, hyper-parameters used etc.).

The selected student model is transferred to the user device in some way using message 44. The message 44 may transfer the selected student model to the user device, or may provide an identifier of the selected student model. The student model is thereby provided to the user device 12, for example for training and inference.

The user device 12 applies the student model (in operation 46). Information, such as performance metrics, are determined and returned to the network node 14 in message 47. As discussed further below, example performance metrics include an evaluation score associated with a performance of the respective student network and radio performance key performance indicators. In some example embodiments, the performance metrics are determined at the network node, for example in response to data provided by the user device 12 in the message 47.

At operation 48, the student model is updated based on a calculated reward value and/or a reinforcement learning policy for the given use case, based, at least in part on information (such as performance metrics) provided in the message 47. Some or all performance metrics used to update the model may be generated at the user device 12 (with or without the assistance of the network node). Alternatively, or in addition, some or all of said performance metrics may be generated at said network node.

As discussed in detail below, the operation 48 may be implemented based on a reward value that is calculated based at least in part, on one or more performance metrics for the selected student algorithm for a given use case. By way of example, the reward value may be calculated based on a weighted sum of a plurality of performance metrics for the selected student algorithm for a given use case.

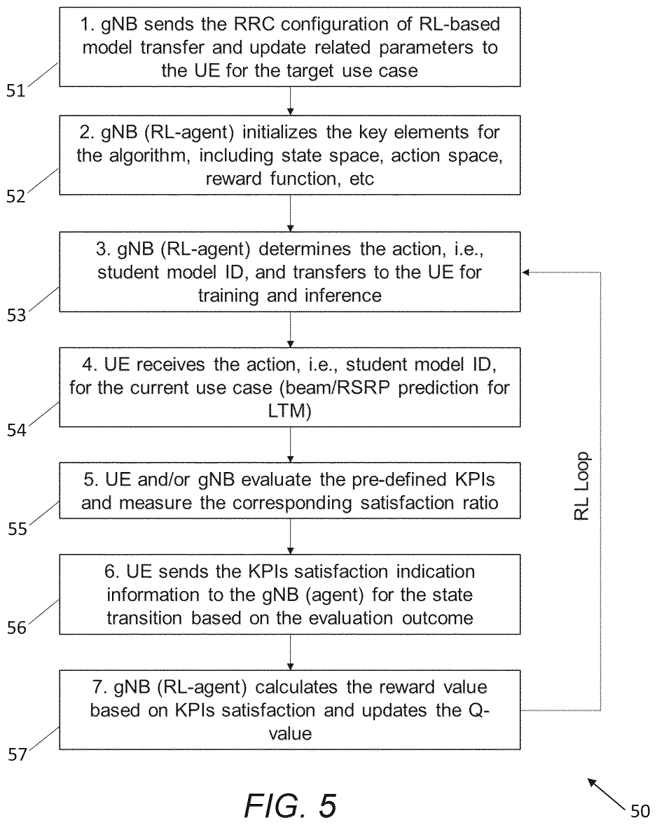

FIG. 5 is a flow chart showing an algorithm, indicated generally by the reference numeral 50, in accordance with an example embodiment. The algorithm 50 provides high level information regarding the operation of a reinforcement learning agent that may be implemented at a gNB (that may, for example, be implementing the network node 14 described above).

The algorithm 50 provides a policy based on reinforcement learning (RL) that allows an agent at the gNB to automatically control the adaptation and optimization of a student model for UE-side training and inference. A teacher-student architecture with knowledge distillation is used. The aim is to achieve a good performance with a verified UE student model quality under varying conditions (e.g. varying mobility patterns, varying radio conditions, traffic conditions, etc).

The algorithm 50 starts at step 1 (indicated by the reference numeral 51), in which the gNB uses an RRC configuration process to start the message exchange 41 of the messages sequence 40 described above.

At step 2 of the algorithm 50 (indicated by the reference numeral 52), key elements of the algorithm are initialised. These elements may include a state space, an action space and/or a reward function. Some of all of the initalised elements may be shared with a UE. Steps 1 and 2 of the algorithm 50 thereby implement message exchange 41.

The state space is a compact form of n-bits (n≥2) information exchange between the gNB and the UE to explicitly indicate the status of desired key performance indicators (KPIs) and the quality of current student model. These parameters can be used to determine the state and reward function of the RL-agent algorithm running at the gNB. RL algorithm parameters such as state space, action space, reward function, action-value function, etc., may be designed for using this indicator. In one example embodiment, the first two bits of the state space indicator convey the following information (although alternative implementations are possible):
When n=2: The first digit of the generated indicator may represent the outcome of a model quality assessment of the derived student model running at the UE side. The second digit of the generated indicator may represent a measure of the interested radio KPI is satisfied or not.
When n>2: The UE indication message is generalized to n bits to reflect the different level of the considered KPIs satisfaction, which is not limited to model satisfaction and radio performance.

The action space is a finite set consisting of possible student ML model architectures, for example all possible student ML model architectures that can be derived from the teacher model.

The reward may be modelled as a weighted sum of n≥2 KPIs corresponding to the components of the state space indication, which reflect different KPIs measures. The potential options for these KPIs include, but are not limited to, ML model satisfaction, radio performance satisfaction, other interested KPIs, etc.

At step 3 of the algorithm 50 (indicated by the reference numeral 53), the RL-agent at the gNB determines a student model ID and transfers the information relating to the selected model to the UE for training and inference (thereby implementing operation 42 and message 44 of the algorithm 40).

At step 4 of the algorithm 50 (indicated by the reference numeral 54) the UE receives the output of step 3 (e.g. a student model ID), thereby completing operation 44 of the algorithm 40. The student model is provided for a particular use case, such as beam selection, RSRP prediction for L1/L2-triggered mobility (LTM), or some other user case.

At step 5 of the algorithm 50 (indicated by the reference numeral 55), key performance indicator (KPIs) or some other performance metrics are generated. These may be generated at the UE and/or at the gNB. A corresponding satisfaction ratio (as discussed in detail below) may also be generated.

At step 6 of the algorithm 50 (indicated by the reference numeral 56), the performance metrics may be sent from the UE to the gNB. Alternatively, or in addition, information that enables the gNB to determine at least some of said performance metrics may be sent. Step 6 is therefore an example of the message 47 of the algorithm 40.

At step 7 of the algorithm 50 (indicated by the reference numeral 57). The RL-agent and the gNB calculate the reward value and updates the model, thereby implementing operation 48 of the algorithm 40.

For the purpose of algorithm design at the gNB, a new format of UE indication signalling is proposed that accounts for the outcome of various UE KPIs satisfaction in the considered radio environment. The resulting low complexity signal can be integrated with available L1/L2 indications, e.g., MAC CE, or UE assistance information in L3.

The algorithm 50 seeks to provide an implementation solution for dynamically configuring different student or sub-models in the UE according to the local radio environment at the UE, in order to obtain a better performance that accounts for both model quality assessment (e.g., prediction accuracy or model confidence level) and target radio KPIs requirement.

In one example embodiments, the message sequence 40 and the algorithm 50 may be implemented using a Q-learning (QL) approach. Alternative approaches to implementing the message sequence 40 and the algorithm 50 (such as Multi-Arm Bandit (MAB), State-Action-Reward-State-Action (SARSA), and Deep Q-Network (DQN), etc.) are also possible.

Further details of an example Q-learning (QL) approach are provided below by way of example. Implementation steps of an example embodiments are provided below, including a main control algorithm for the proposed RL model update algorithm to function in two different modes: warm-up/exploration and exploitation.

The example QL modelling approach includes the following elements, which are discussed in detail below: agent, environment, observation, action space, state space, reward function, and policy. Some of these concepts have been introduced above.

Agent: As discussed in the example algorithm 50, a gNB can act as a reinforcement learning (RL) agent. The RL agent is used to determine the student model that consists of model parameters, architectures, or selection among several potential existing models, according to the policy of RL-based algorithm. A compression strategy may be learnt using RL, that takes a teacher network as input and systematically outputs a smaller student network to UE for the interested use case.

Environment: The radio environment for the desired use case may be used in implementing example embodiments. For example, when a mobile scenario is considered, the radio environment to be interacted with the RL agent at the gNB may comprise factors such as a cellular network layout, propagation channel, grid of beams (GoBs) and multiple-input-multiple-output (MIMO) configuration, user mobility settings (e.g. speed) etc. In addition, the impact of model inference in the relevant use case (such as beam/cell or RSRP prediction) also accounts for the entity of environment as it also determines the UE experienced KPIs variation.

Observation: The environment is characterized by many factors (see above). For practical reasons, the RL agent may use only a set of selected observations in order to perform the exploration actions and learn an RL policy. The selected observations may be defined in terms of use case specific radio KPIs, such as user throughput [kbps], the number of handover failures (HOFs) or radio link failures (RLFs), the number of beam failure, the time of outage, and the student model quality assessment.

The action space is a finite set consisting of student ML model architectures (e.g. all possible student ML model architectures that can be derived from the teacher model, although it should be noted that the action space may be modelled in other ways in some example embodiments).

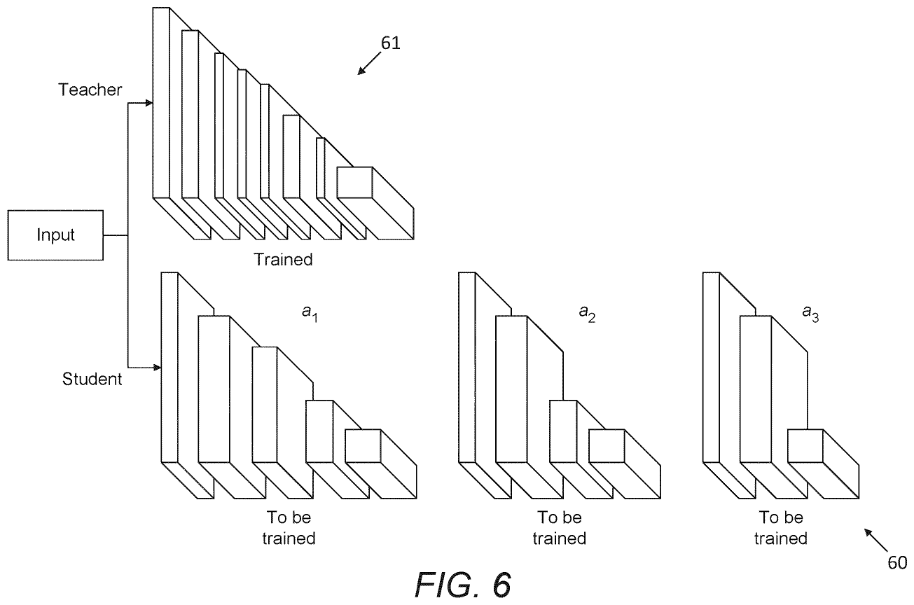

FIG. 6 is a block diagram of models, indicated generally by the reference numeral 60, in accordance with an example embodiment.

A relatively complex teacher model 61 is compressed by three different student models a₁, a₂, a₃, with fewer hidden layers than the teacher model 61. The action space in this example is defined as [symbol] ={a₁, a₂, a₃}. Of course, more or fewer than three student models may be provided in some example embodiments.

The use of simpler student models may limit a search space while performing RL exploration. Furthermore, the student models may, in some example embodiments, be prepared beforehand, such that there is no need to revise or adapt the source code while performing the RL iteration.

Other ways of modelling the action space include:
Layer reduction action, where each action index corresponds to how many layers should be reduced (or added). An example way of modelling can be [symbol] ={−3,−2,−1,0,1,2,3}. The agent will control to systematically reduce/add the neural network (NN) layers from the teacher model.
Layer shrinkage action, where each action index corresponds to how much to shrink the layer parameters. An example way of modelling can be [symbol] ={0.1,0.2, . . . ,0.9,1.0}.
Multi-dimensional action space, where each action index corresponds to two elements where the first one indicates the layer reduction, and the second one indicates the layer shrinkage (as mentioned above). An example way of modelling can be

$$𝒜 = \{ ( {a}_{r}^{1} , {a}_{s}^{1} ) , ( {a}_{r}^{2} , {a}_{s}^{2} ) , … , ( {a}_{r}^{N} , {a}_{s}^{N} ) \} .$$

As discussed above, the state space comprises a plurality of bits for use in quantifying said performance metrics, wherein said state space configuration defines the number and nature of said bits. Thus, the state space is a compact form of n-bit (n≥2) information exchange between the gNB and the UE to explicitly indicate the status of desired key performance indicators (KPIs) and the quality of current student model.

In example embodiments with UE indication n≥2 bits representation, there are 4 state indices, i.e., [symbol] ={s₁, s₂, s₃, s₄}={00, 01, 10, 11}. In general n≥2, depending on the requirements to consider more KPIs, which is use case dependent.

The first digit (of a 2-bit state space indication) may represent the outcome of model quality assessment for current received student model at the UE. Denoting the model quality evaluation score as f_{M}∈[0,1], the first digit may be defined by

$${d}_{1} = \{ \begin{matrix}1 & {f}_{M} \geq {γ}_{M} \\ 0 & {f}_{M} < {γ}_{M}\end{matrix} ,$$

where γ_{M} is the network configuration threshold that represents the model quality acceptance ratio.

There are various ways to define the model quality evaluation score, such as prediction accuracy,

$${f}_{M} = \frac{1}{\vert {D}_{e v a l} \vert} {\sum }_{i ∈ {D}_{e v a l}} 1 ( {\hat{y}}_{i} = {y}_{i} ) ,$$

where ŷᵢ is the prediction and yᵢ is the ground truth for the i-th sample. 1(·) is the indicator function. The data set within the RL interval is Dₑᵥₐₗ.

Other modelling examples, such as prediction MSE, confidence, negative log likelihood, Expected Calibration Error (ECE), may also be used.

The second digit (of a 2-bit state space indication) may represent the interested radio KPIs satisfaction by taking the received student model for inference. Denoting the radio KPIs evaluation score as f_{R}∈[0,1], the second digit may be defined by

$${d}_{2} = \{ \begin{matrix}1 & {f}_{R} \geq {γ}_{R} \\ 0 & {f}_{R} < {γ}_{R}\end{matrix} ,$$

where γ_{R} is the network configured threshold that represents the radio KPIs satisfaction ratio. f_{R} and γ_{R} depend on the specific use case, as discussed further below in an example use case

The use of a 2-bit state space enables the state space to be linked to the reward function design and limits the state space to 4 indices only. However, it is possible to use more than 2-bits to described the state space, i.e., n>2, for example where more than 2 above mentioned KPIs are considered.

In one example embodiment, a model complexity score is introduced as a penalty term that is subjected to the overall reward function. Denoting the model complexity score as f_{C}∈[0,1], an extended (or third) digit of the state space may be defined by

$${d}_{3} = \{ \begin{matrix}1 & {f}_{C} \geq {γ}_{C} \\ 0 & {f}_{C} < {γ}_{C}\end{matrix} ,$$

where γ_{C} is the network configured threshold that represents the model complexity satisfaction ratio.

Various ways of modelling f_{C}∈[0,1] available:

$${f}_{C} = \frac{{N}_{S}^{hl}}{{n}_{T}^{hl}} ,$$

where

$${N}_{S}^{hl}$$

is the number of hidden layers in student model,

$${N}_{T}^{hl}$$

is the number of hidden layers in teacher model; or

$${f}_{C} = \frac{{N}_{S}^{h p}}{{N}_{T}^{h p}} , \qquad 2 )$$

where

$${N}_{S}^{h p}$$

is the number of hyper parameters in student model,

$${N}_{T}^{h p}$$

is the number of hyper parameters in teacher model.

It is worth noting that other type of KPIs can also be applied to further extend the state space in addition to, or instead of, any of the KPIs referred to above.

The reward function may be a weighted sum of n≥2 KPIs corresponding to the components of the state space indication. These may include:
Model evaluation score f_{M}∈[0,1]: a score associated with a given reduced student network structure/state, e.g., prediction accuracy, confidence measure, calibrated confidence, etc.
Radio KPIs evaluation score f_{R}∈[0,1]: a score associated with a given use case, such as normalized throughput, outage/failure probability, etc.
Other KPIs. One example is model complexity score f_{C}∈[0,1]. The higher value of f_{c} means more complex introduced to the present action/student model.

The reward function may be formulated by:

$$R \{ s , a \} = {ρ}_{1} \times {f}_{M} + {ρ}_{2} \times {f}_{R} + {ρ}_{3} \times ( - {f}_{c} ) + … + {ρ}_{n} \times {f}_{n}$$

where the weight factor ρ₁, ρ₂, ρ₃, . . . , ρₙ ∈[0,1] is introduced to control the optimization objective. For example, ρ₁+ρ₂+ρ₃+ . . . +ρₙ=1 can be applied for tradeoff between both qualification measures.

The policy (e.g. Q-table) is a lookup table created to store the learned knowledge during the RL exploration and exploitation. Each entry of the Q-table Q(s, a) may store the discounted reward value of current state and action pair. Thus, the Q-table is a look-up table that can be used to collate at least some of said performance metrics and rewards.

The dimensions of the Q-table may be determined by the size of state and action space. By choosing the binary digits for state space modelling, it is also helpful to reduce the algorithm complexity for final convergence.

The approach can be extended to Deep Q-Learning where a neural network is used to approximate the Q-value function. The state is taken as the input, and the Q-value of all possible actions Q(s, a) is generated as the output. The following steps may be involved in RL using deep Q-learning networks (DQNs): 1) Past experiences are stored in memory; 2) The maximum output of the Q-network determines the next action; 3) The loss function is defined as the mean square error of the target Q-value Q*(s, a) and the predicted Q-value Q(s, a).

As mentioned above, QL is described by way of example only; other RL-based methods such as Multi-Arm Bandit (MAB), State-Action-Reward-State-Action (SARSA), and Deep Q-Network (DQN), etc. may also be used.

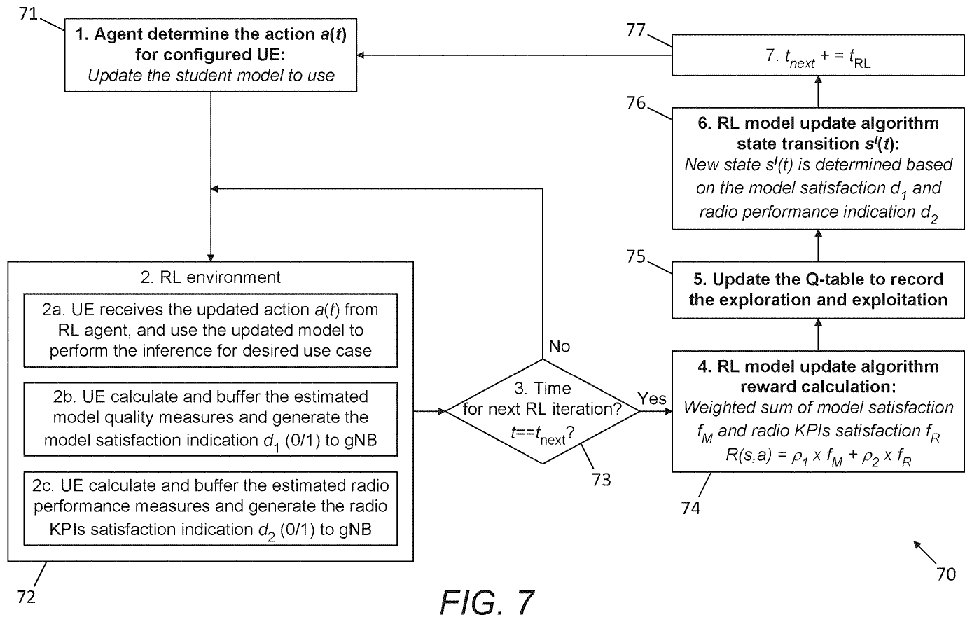

FIG. 7 is a flow chart showing an algorithm, indicated generally by the reference numeral 70, in accordance with an example embodiment. The algorithm 70 shows implementation steps of an example embodiment.

At step 1 of the algorithm 70 (indicated by the reference numeral 71), the RL-agent at a network node determines the action a(t) to be taken for the configured user device.

Depending on the modelling assumptions, the action corresponds to a certain determined student ML model for UE to perform training and inference. In the algorithm 70, according to the epsilon greedy policy, the action can be either randomly taken or selected according to the maximum Q-value in the Q-table.

Step 2 of the algorithm 70 (indicated by the reference numeral 72) show interactions between the environment and the agent after the action determination. As shown in FIG. 7, step 2 comprises sub-steps 2a, 2b and 2c.

At step 2a, the user device receives the action from gNB (as generated in step 1). The action contains the determined student model ID for training and inference, or the action to monitor the current student model such as layer reduction, addition, or shrinking, etc.

At step 2b, the user device calculates and buffers the model quality performance within the current RL interaction interval, and generates the model satisfaction indication for provision to the network.

At step 2c, the user device calculates and buffers the desired KPI measures within the current RL interaction interval, and generates the radio KPIs satisfaction indication for providing to the network.

A further step (step 2d) may optionally be provided in which the user device calculates and buffers other interested KPI measures, e.g., model complexity, within the current RL interaction interval, and generates the corresponding satisfaction indication for provision to the gNB.

At step 3 of the algorithm 70 (indicated by the reference numeral 73), a check is performed regarding whether it is the time for the next RL iteration (i.e. whether RL training is considered to be complete). The step 73 may be implemented in many ways.

If so, the algorithm 70 moves to step 4, where the network node gNB prepares to estimate the reward by the end of the current iteration step. Otherwise, the algorithm 70 returns to step 2, where the buffering of the desired KPI and model quality measures is continued.

At step 4 of the algorithm 70 (indicated by the reference numeral 74), the network node calculates the instantaneous reward value R(s(t), a(t)).

According to the determined KPIs for the UE to measure, several independent terms may constitute the reward function for these KPIs: 1) Model evaluation score, f_{M}, 2) Radio KPIs evaluation score, f_{R}. As an extension, other KPIs such as model complexity score may also be considered.

A scalar weighting factor or a weighting vector may be introduced to control the contribution of different considered terms in the overall optimization objective.

At step 5 of the algorithm 70 (indicated by the reference numeral 75), the relevant entry of the Q-table for the current state and action pair is updated as follows:

The updating rule follows Bellman equation:

$$Q ( s ( t ) , a ( t ) ) ← ( 1 - α ) Q ( s ( t ) , a ( t ) ) + α \{ r ( s ( t ) , a ( t ) ) + γ {max}_{a ∈ A} Q ( {s}^{′} ( t + {t}_{R L} ) , a ( t ) ) \} ,$$

where α is the learning rate, γ is the discounting factor.

At step 6 of the algorithm 70 (indicated by the reference numeral 76), the state transition phase is controlled based on the determined action at the current time step. As described above, a new state index may be determined based on the satisfaction of individual KPIs with respect to the network configured thresholds.

Step 7 of the algorithm 70 (indicated by the reference numeral 77) controls the move to the next RL iteration.

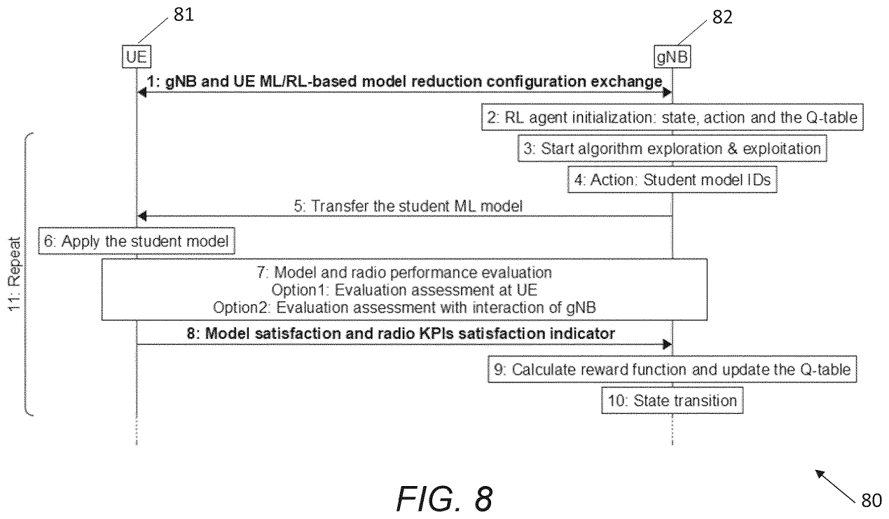

FIG. 8 is a message flow sequence, indicated generally by the reference numeral 80, showing an example implementation of an algorithm in accordance with an example embodiment.

The message flow sequence 80 shows a signalling flow of an example model update algorithm between UE 81 and gNB 82.

Step 1 of the algorithm 80 consists of gNB and UE ML/RL-based model update and transfer capability exchange. Step 1 is therefore an example implementation of the operation 41 of the algorithm 40 described above.

Step 1 of the algorithm 80 uses RRC-based signalling between the gNB and configured UE. The configuration signal may include the following aspects:
Configuring the gNB to use 2-bit binary indicator message with the relevant thresholds including model quality satisfaction ratio γ_{M} and radio KPIs satisfaction ratio γ_{R} for the UE to measure. As an extended approach, gNB can also configure to use more sophisticated n-bits indicator with more assessment thresholds for different target KPIs.
The ML-based algorithm (RL) may be selected with the relevant components including state space, action space, reward function and policy (Q-table), etc. This action-value function can also be replaced by other approximation functions, such as DQN. The design of RL-based algorithm is related to the selected indicator message such as state space, reward and Q-table.
Other RL-based RRM coordination mechanism.

The RL agent at the gNB 82 is initialised in step 2. The algorithm enters an exploration and exploitation mode in step 3. Student model(s) are determined and transferred to the UE 81 (steps 4 and 5) before being implemented in step 6. The steps 2 to 6 may be implemented in accordance with the algorithms 50 and 70 described in detail above.

Step 7 of the algorithm 80 implements model quality assessment and radio performance evaluation. Two options for implanting step 7 are indicated in FIG. 8.

Option 1: Evaluation assessment at the UE. This may be most suitable for the case when UE holds the ground truth in order to verify the model prediction accuracy, which is selected as the measure of model quality, f_{M}. The UE specific radio KPI f_{R}, e.g., user throughput, the number of RLFs/HOFs, time of outage, etc, is selected for verification. As configured in Step 1, the verification procedure is based on the network configured thresholds for both measures, i.e., γ_{M} and γ_{R}.

Option 2: Evaluation assessment with gNB assistance. This may be most suitable for the case when the network holds the ground truth in order to verify the model prediction accuracy, which is selected as the measure of model quality, f_{M}. Furthermore, the NW system radio KPI f_{R} is applied such as cell throughput, total number of HOs/PPs, mean outage, etc for verification. As configured in Step 1, the verification procedure is based on the network configured thresholds for both measures, i.e., γ_{M} and γ_{R}. This may require gNB-UE level interaction signalling.

In step 8 of the algorithm 80, a UE model satisfaction and radio KPIs satisfaction indication is signalled from the UE 81 to the gNB 82.

The signalling may be in accordance with a pre-configured signal format of the indication message and the given thresholds that account for the student model satisfaction measure and radio KPIs satisfaction measure from the gNB, UE generates an n-bit (e.g. 2-bit) information to gNB as discussed in step 1 above. Based on this compound indicator, gNB can have knowledge of the impact of each action to the desired use case by using the transferred student model.

Optionally, a feedback message from the gNB 82 to the UE 81 may be provided.

Steps 9-11 of the algorithm 80 relate to instantaneous reward calculation, Q-table update, state transition and iteration step update. These are in accordance with the algorithm 70 described above.

### Example Use Case-ML Mobility

In the example use case discussed below, we apply the RL framework described above to execute model transfer between a gNB and a configured UE for an LTM use case. It is assumed that the larger teacher model is trained at the network level with more characteristics to perform the sequence of predictions for mobility management. In order to satisfy per UE capability requirements and mobility KPIs, a set of student models are derived from the teacher model in order to achieve the similar prediction functionalities in the present use case. A training objective is to maximize the accumulative reward in the iteraction loop such that the prediciton accuracy or confidence score delivered by the student model hosted by UE, and mobility performance such as outage probability is jointly optimized.

### RL Modeling Entities:

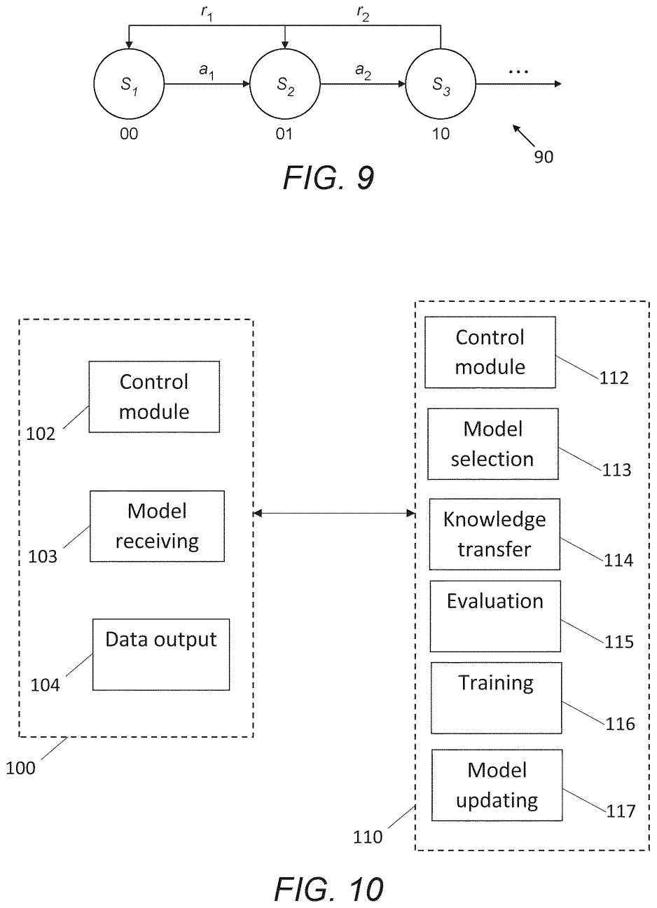

State space. In this example use case, each state index consists of at least two individual digits where the first digit represents the outcome of the model quality, modelled by prediction accuracy here, and the second digit represents the satisfaction of outage probability in current RL iteration period. Thus, the fully state space is given by: [symbol] ={s₁, s₂, s₃, s₄}={00, 01, 10, 11} as shown in FIG. 9, which shows an example state space model, indicated generally by the reference numeral 90.
Action space. Each action corresponds to a separate student model extracted by the teacher model, and the student model will be transferred to the UE for beam RSRP prediction as illustrated below. The full action space is modelled as [symbol] ={a₁, a₂, a₃, . . . } which is determined beforehand according to knowledge distillation.
Reward function. As described above, the reward function is modelled by two parts, model evaluation score to assess the quality of applied student model (action), and radio KPIs evaluation score to quantify the measure of mobility performance.
   Sigmoid function

$$f ( x ) = \frac{1}{1 + {e}^{- x}}$$

is used to normalize the range of both scores to [0,1].
Model evaluation score: f_{M}(ε)=1/{1+e^{-(ε-γ}^{_{M}}⁾}, where

$$ε = \frac{Correct prediction samples}{Total prediction samples}$$

is the prediction accuracy.
Radio KPIs evaluation score: f_{R}(O)=1/{1+e^{-(o-γ}^{_{R}}⁾}, where

$$o = \frac{Time of outage}{Total execution time}$$

is the outage probability, time of outage is evaluated within the total execution time per RL iteration interval.

Thus, the formulation of reward function is given by: R(s, a)=ρ×f_{M}(ε)+(1−ρ)×f_{R}(o), where ρ∈[0,1].

FIG. 10 is a block diagram of a system in accordance with an example embodiment. The system of FIG. 10 includes a user device 100 and a network node 110. The user device 100 and the network node 110 may be used to implement aspects of the algorithms and message sequences 20, 40, 50, 70 and 80 described above.

The user device 100 comprises a control module 102 for exchanging configuration information with the network node 110, a model receiving module 103 for receiving a student model, or an identifier of the student model, from the network node 110, and a data output module 104 for providing at least some information to the network node 110.

The network node 110 comprises a control module 112 for exchanging configuration information with the user device 100 (e.g. with the control module 102), a model selection module 13 for selecting a student model from a set of student model architectures, a knowledge transfer module 114 for transferring the selected student model, or an identifier of the selected student model, to the user device 100 (e.g. to the model receiving module 103), an evaluation module 115 for calculating a reward value based, at least in part, on one or more performance metrics for the selected student algorithm for a given use case (which metrics may be received from the data output module 104), a training module 116 for updating the student model based on the calculated reward value and/or a reinforcement learning policy for the given use case, and a model updating module 117 for repeating the selecting, transferring, calculating and updating steps above.

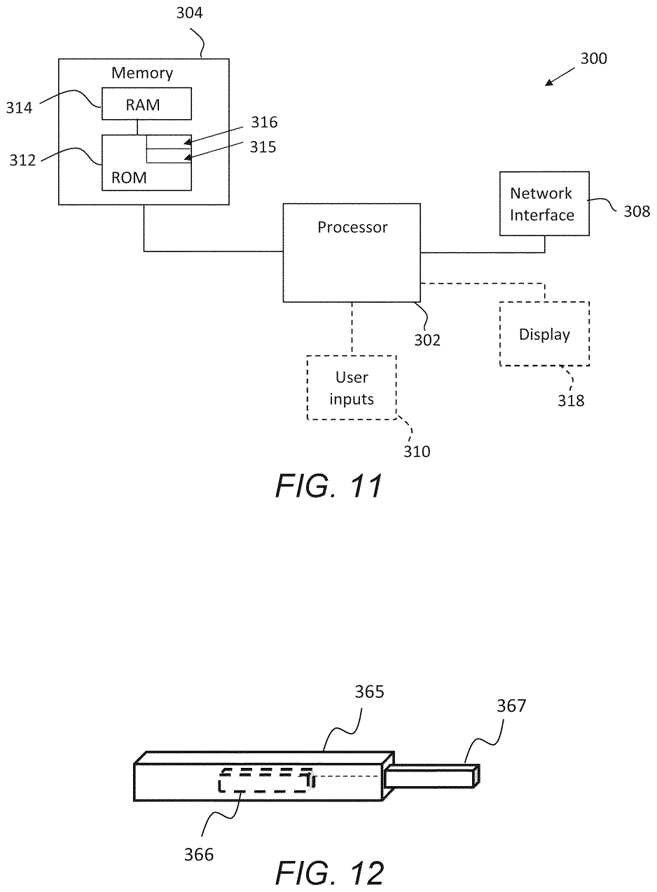

For completeness, FIG. 11 is a schematic diagram of components of one or more of the example embodiments described previously, which hereafter are referred to generically as a processing system 300. The processing system 300 may, for example, be (or may include) the apparatus referred to in the claims below.

The processing system 300 may have a processor 302, a memory 304 coupled to the processor and comprised of a random access memory (RAM) 314 and a read only memory (ROM) 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the methods, algorithms and sequences 20, 40, 50, 70 and 80 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 12 shows tangible media, specifically a removable memory unit 365, storing computer-readable code which when run by a computer may perform methods according to example embodiments described above. The removable memory unit 365 may be a memory stick, e.g. a USB memory stick, having internal memory 366 for storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and sequences of FIGS. 2, 4, 5, 7 and 8 are examples only and that various operations depicted therein may be omitted, reordered and/or combined.

It will be appreciated that the above-described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising:
at least one memory configured to store instructions; and
at least one processor configured to execute the instructions and cause the apparatus to perform,
exchanging configuration information with a user device of a mobile communication system;
selecting a student model from a set of student model architectures, wherein each student model architecture in the set is derived from a teacher model for implementing a function at said user device;
transferring the selected student model, or an identifier of the selected student model, to the user device for training and inference;
calculating a reward value based, at least in part, on one or more performance metrics for the selected student algorithm for a given use case; and
updating the student model based on the calculated reward value and/or a reinforcement learning policy for the given use case.

2. An apparatus as claimed in claim 1, wherein the apparatus is further caused to perform:
repeating the selecting, transferring, calculating and updating steps above.

3. An apparatus as claimed in claim 1, wherein the apparatus is a network node of the mobile communication system.

4. An apparatus as claimed in claim 1, wherein the apparatus is further caused to perform:
receiving at least some of said performance metrics from said user device.

5. An apparatus as claimed in claim 1, wherein said performance metrics include:
an evaluation score associated with a performance of the respective student network; and/or
radio performance key performance indicators for a given use case.

6. An apparatus comprising:
at least one memory configured to store instructions; and
at least one processor configured to execute the instructions and cause the apparatus to perform,
exchanging configuration information with a network node of a mobile communication system;
receiving a student model, or an identifier of the student model, from the network node, for training and inference, wherein said student model is selected from a set of student model architectures, wherein each student model architecture in the set is derived from a teacher model for implementing a function at said user device; and
providing at least some information to the network node, for use in updating the student model based, at least in part, on a said information.

7. An apparatus as claimed in claim 6, wherein said information includes performance metrics for the student model for a given use case.

8. An apparatus as claimed in claim 6, wherein said configuration information includes a state space configuration, wherein the state space comprises a plurality of bits for use in quantifying said performance metrics, wherein said state space configuration defines the number and nature of said bits.

9. An apparatus as claimed in claim 8, wherein one or more bits of said state space indicates whether or not a model quality assessment for a student model is above a threshold score.

10. An apparatus as claimed in claim 8, wherein one or more bits of said state space indicates whether radio key performance indicators are above a threshold satisfaction level.

11. An apparatus as claimed in claim 1, wherein said configuration information includes an action space configuration.

12. A method comprising:
exchanging configuration information with a user device of a mobile communication system;
selecting a student model from a set of student model architectures, wherein each student model architecture in the set is derived from a teacher model for implementing a function at said user device;
transferring the selected student model, or an identifier of the selected student model, to the user device for training and inference;
calculating a reward value based, at least in part, on one or more performance metrics for the selected student algorithm for a given use case;
updating the student model based on the calculated reward value and/or a reinforcement learning policy for the given use case; and
repeating the selecting, transferring, calculating and updating steps above.

13. A method comprising:
exchanging configuration information with a network node of a mobile communication system;
receiving a student model, or an identifier of the student model, from the network node, for training and inference, wherein said student model is selected from a set of student model architectures, wherein each student model architecture in the set is derived from a teacher model for implementing a function at said user device; and
providing at least some information to the network node, for use in updating the student model based, at least in part, on a said information.

14.-15. (canceled)
